(19) United States
(12) Patent Application Publication
(10) Pub. No.: US 2026/0274304 A1
(43) Pub. Date: Sep. 17, 2026

(54) FAIL-SAFE CORRECTIVE ACTIONS BASED ON VISION INFORMATION FOR AUTONOMOUS VEHICLES

(71) Applicant: TESLA, INC., Austin, TX (US)

(72) Inventors: Uma BALAKRISHNAN, Austin, TX (US); Daniel HUNTER, Austin, TX (US); Akash CHAURASIA, Austin, TX (US); Yun-Ta TSAI, Austin, TX (US); Akshay Vijay PHATAK, Austin, TX (US)

(73) Assignee: TESLA, INC., Austin, TX (US)

(21) Appl. No.: 19/648,542

(22) Filed: Apr. 15, 2026

Related U.S. Application Data
(63) Continuation of application No. 18/320,717, filed on May 19, 2023, now Pat. No. 12,623,691.
(60) Provisional application No. 63/365,078, filed on May 20, 2022.
(60) Provisional application No. 63/365,050, filed on May 20, 2022.

(51) Int. Cl. B60W 60/00; G06V 20/56

(52) U.S. Cl. CPC B60W 60/00182; G06V 20/56; B60W 2420/403; B60W 2555/20

(57) ABSTRACT

Systems and methods for fail-safe corrective actions based on vision information for autonomous driving. An example method is implemented by a processor system included in a vehicle, with the method comprising obtaining images from image sensors positioned about the vehicle. Visibility information is determined for at least a portion of the images. Adjustment of operation of an autonomous vehicle is caused based on the visibility information.

### CROSS-REFERENCE TO RELATED APPLICATIONS

This application is a continuation application of U.S. patent application Ser. No. 18/320,717, filed May 19, 2023, which claims priority to U.S. Provisional Patent Application No. 63/365,050, filed on May 20, 2022, and claims priority to U.S. Provisional Patent Application No. 63/365,078, filed on May 20, 2022, the disclosures of which are hereby incorporated herein by reference in their entirety.

### BACKGROUND

### Technical Field

The present disclosure relates to machine learning models, and more particularly, to machine learning models using vision information.

### Description of Related Art

Neural networks are relied upon for disparate uses and are increasingly forming the underpinnings of technology. For example, a neural network may be leveraged to perform object classification on an image obtained via a user device (e.g., a smart phone). In this example, the neural network may represent a convolutional neural network which applies convolutional layers, pooling layers, and one or more fully-connected layers to classify objects depicted in the image. As another example, a neural network may be leveraged for translation of text between languages. For this example, the neural network may represent a recurrent-neural network.

Complex neural networks are additionally being used to enable autonomous or semi-autonomous driving functionality for vehicles. For example, an unmanned aerial vehicle may leverage a neural network to, in part, enable autonomous navigation about a real-world area. In this example, the unmanned aerial vehicle may leverage sensors to detect upcoming objects and navigate around the objects. As another example, a car or truck may execute neural network(s) to autonomously or semi-autonomously navigate about a real-world area. At present, such neural networks may rely upon costly, or error-prone, sensors. Additionally, such neural networks may lack accuracy with respect to detecting and classifying objects causing deficient autonomous or semi-autonomous driving performance.

### BRIEF DESCRIPTION OF THE DRAWINGS

FIG. 1 is a block diagram illustrating an example autonomous or semi-autonomous vehicle which includes a multitude of image sensors an example processor system.

FIG. 2A is a block diagram illustrating the processor system determining visibility information based on received images.

FIG. 2B is a block diagram illustrating examples of visibility information determined based on a received image.

FIGS. 2C-2E illustrate example images labeled with grids of visibility values.

FIG. 3A is a block diagram illustrating example signals/corrective actions to be used by an autonomous vehicle.

FIG. 3B is a block diagram illustrating an example user interface identifying an example signal/corrective action.

FIG. 4 is a flowchart an example process for determining visibility information to be used in autonomous driving.

FIG. 5 is a block diagram illustrating the processor system determining visibility information using a virtual camera network.

FIG. 6 is a block diagram illustrating an example vehicle which includes the vehicle processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction

This application describes techniques to monitor for, and take fail-safe actions in response to, reduced visibility of image sensors during autonomous or semi-autonomous driving of an autonomous vehicle (collectively referred to herein as autonomous driving). During operation of an autonomous vehicle, sensor information may be received, and processed, to effectuate autonomous driving. As may be appreciated, the sensors used to obtain the sensor information may have reduced visibility based on current weather (e.g., fog, snow, rain), objects blocking the sensors, and so on. Thus, to ensure safe and accurate autonomous driving this application describes techniques to reliably identify visibility issues. For example, a machine learning model (e.g., a convolutional neural network) may be used to characterize or model visibility associated with the sensor information. Based on the visibility issues, certain correction actions may be taken. For example, braking may be applied, or autonomous operation may be temporarily turned off, to enable a person to take over driving.

The autonomous driving described herein may use image sensors, such as cameras, which are positioned about an autonomous vehicle. The image sensors may obtain images at a particular frame rate, or an adjustable frame rate, such as 30 Hz, 35 Hz, 60 Hz, and so on. In contrast to other autonomous driving techniques, in some embodiments only image sensors may be used. Thus, the autonomous driving may be performed using a vision-based system to identify objects and signals associated with the objects (e.g., a current lane of a vehicle, whether a vehicle has its door open, and so on). Example objects may include vehicles, pedestrians, strollers, bikers, skateboarders, traffic signs, and so on.

In contrast, prior autonomous driving techniques may leverage other sensors. For example, radar may be used to, at least in part, detect objects which are proximate to an autonomous vehicle. Radar may also be used to inform velocities of these objects. During autonomous driving, radar may therefore be used to inform the presence, and/or velocity, of objects which are proximate to the autonomous vehicle. However, use of radar may introduce errors which cause deficient performance as compared to a vision-based technique. For example, radar may lead to phantom objects being detected. In this example, the autonomous vehicle may apply braking based on these phantom objects. As another example, combining radar and image sensors may introduce errors or complications which would not arise using only image sensors.

Thus, the description herein is focused on use of a vision-based machine learning model to determine information associated with objects proximate to an autonomous vehicle. As may be appreciated, however, the techniques described herein may be applied to any autonomous vehicle which uses image sensors (e.g., including those with other sensors, such as radar, Lidar, and so on). Since image sensors are being used, there may be situations in which visibility of these image sensors is reduced. As an example with respect to rain, a vehicle traveling in front of the autonomous vehicle may cause tire spray of water to occlude the vehicle. As another example, image sensors may depict a portion of an upcoming road segment as occluded by dense fog.

This application therefore describes techniques to identify, and mitigate the effects of, such reduced visibility conditions. For example, autonomous driving behavior may be adjusted based on the reduced visibility. Examples of adjusting behavior may include causing the autonomous vehicle to slow down, to change lanes, to pull over to the side of the road, to activate wipers, to activate a heater grid on a front or rear windshield (e.g., to remove snow or condensation, to function as a defogger), and so on.

### Block Diagrams

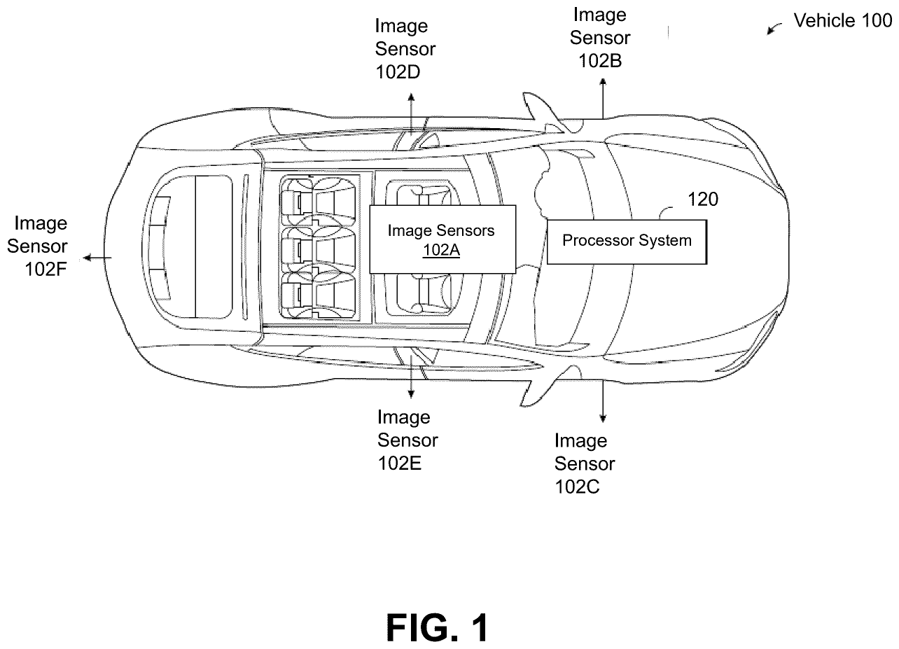

FIG. 1 is a block diagram illustrating an example autonomous vehicle 100 which includes a multitude of image sensors 102A-102F an example processor system 120. The image sensors 102A-102F may include cameras which are positioned about the vehicle 100. For example, the cameras may allow for a substantially 360-degree view around the vehicle 100.

The image sensors 102A-102F may obtain images which are used by the processor system 120 to, at least, determine information associated with objects positioned proximate to the vehicle 100. The images may be obtained at a particular frequency, such as 30 Hz, 36 Hz, 60 Hz, 65 Hz, and so on. In some embodiments, certain image sensors may obtain images more rapidly than other image sensors. As will be described below, these images may be processed by the processor system 120 based on the vision-based machine learning model described herein.

Image sensor A 102A may be positioned in a camera housing near the top of the windshield of the vehicle 100. For example, the image sensor A 102A may provide a forward view of a real-world environment in which the vehicle is driving. In the illustrated embodiment, image sensor A 102A includes three image sensors which are laterally offset from each other. For example, the camera housing may include three image sensors which point forward. In this example, a first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow lens. In this way, three images of varying focal lengths may be obtained in the forward direction by the vehicle 100.

Image sensor B 102B may be rear-facing and positioned on the left side of the vehicle 100. For example, image sensor B 102B may be placed on a portion of the fender of the vehicle 100. Similarly, Image sensor C 102C may be rear-facing and positioned on the right side of the vehicle 100. For example, image sensor C 102C may be placed on a portion of the fender of the vehicle 100.

Image sensor D 102D may be positioned on a door pillar of the vehicle 100 on the left side. This image sensor 102D may, in some embodiments, be angled such that it points downward and, at least in part, forward. In some embodiments, the image sensor 102D may be angled such that it points downward and, at least in part, rearward. Similarly, image sensor E 102E may be positioned on a door pillow of the vehicle 100 on the right side. As described above, image sensor E 102E may be angled such that it points downwards and either forward or rearward in part.

Image sensor F 102F may be positioned such that it points behind the vehicle 100 and obtains images in the rear direction of the vehicle 100 (e.g., assuming the vehicle 100 is moving forward). In some embodiments, image sensor F 102F may be placed above a license plate of the vehicle 100.

While the illustrated embodiments include image sensors 102A-102F, as may be appreciated additional, or fewer, image sensors may be used and fall within the techniques described herein.

The processor system 120 may obtain images from the image sensors 102A-102F and detect objects, and signals associated with the objects, using a vision-based machine learning model. Based on the objects, the processor system 120 may adjust one or more driving characteristics or features. For example, the processor system 120 may cause the vehicle 100 to turn, slow down, brake, speed up, and so on.

In some embodiments, the processor system 120 may include one or more matrix processors which are configured to rapidly process information associated with machine learning models. The processor system 120 may be used, in some embodiments, to perform convolutions associated with forward passes through a convolutional neural network. For example, input data and weight data may be convolved. The processor system 120 may include a multitude of multiply-accumulate units which perform the convolutions. As an example, the matrix processor may use input and weight data which has been organized or formatted to facilitate larger convolution operations.

For example, input data may be in the form of a three-dimensional matrix or tensor (e.g., two-dimensional data across multiple input channels). In this example, the output data may be across multiple output channels. The processor system 120 may thus process larger input data by merging, or flattening, each two-dimensional output channel into a vector such that the entire, or a substantial portion thereof, channel may be processed by the processor system 120. As another example, data may be efficiently re-used such that weight data may be shared across convolutions. With respect to an output channel, the weight data 106 may represent weight data (e.g., kernels) used to compute that output channel.

Additional example description of the processor system, which may use one or more matrix processors, is included in U.S. Pat. No. 11,157,287, U.S. Patent Pub. 2019/0026250, and U.S. Pat. No. 11,157,441, which are hereby incorporated by reference in their entirety and form part of this disclosure as if set forth herein.

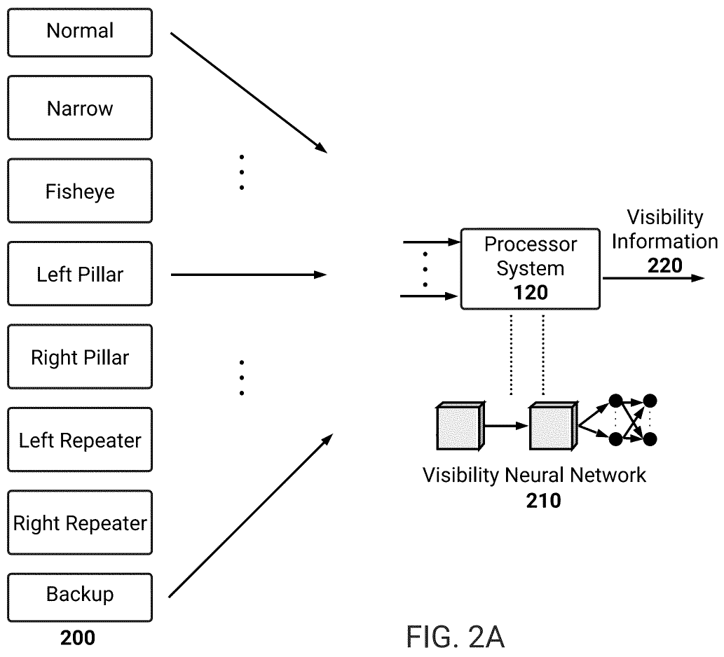

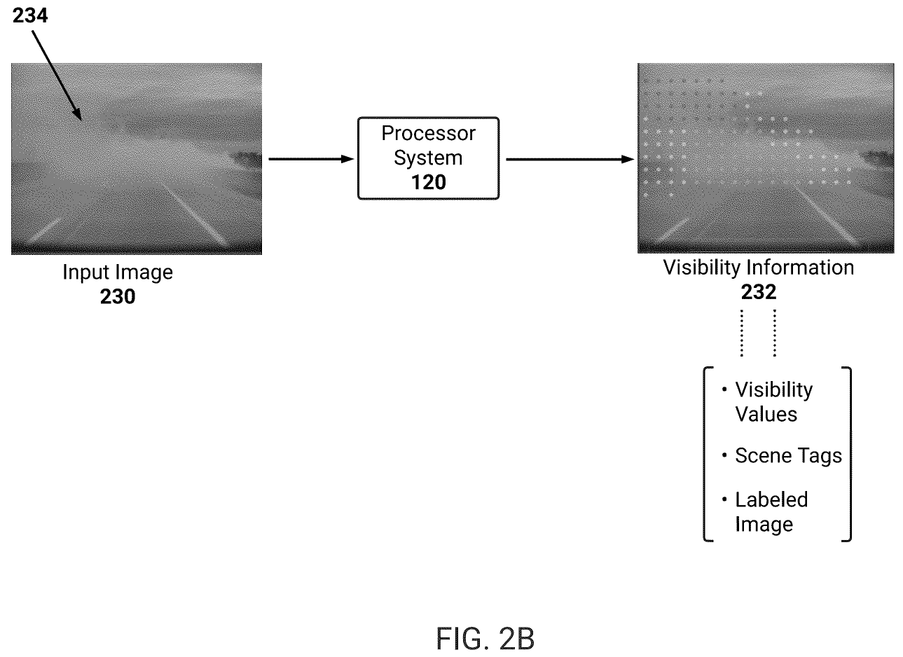

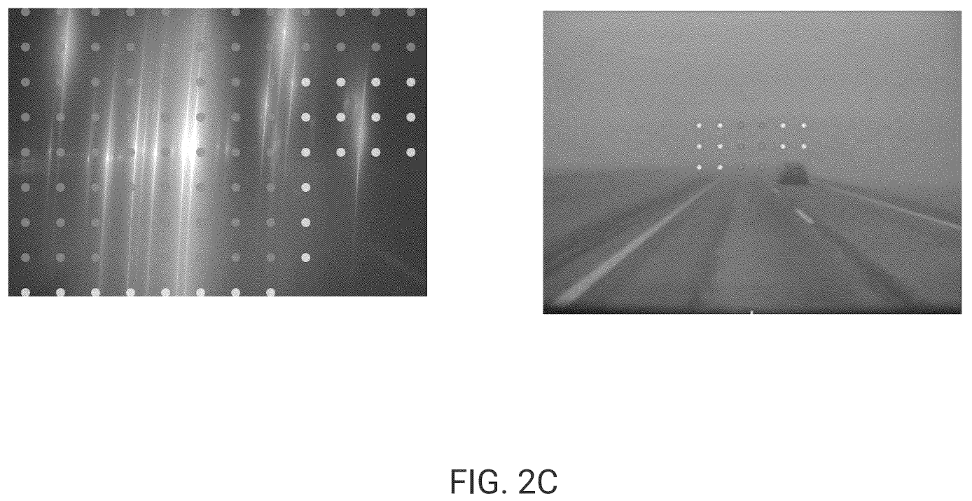

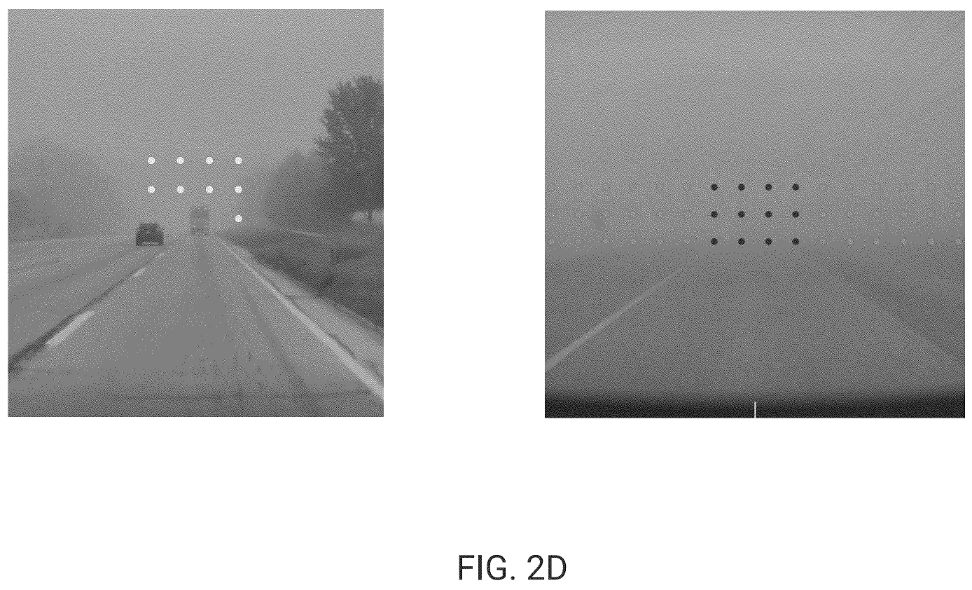

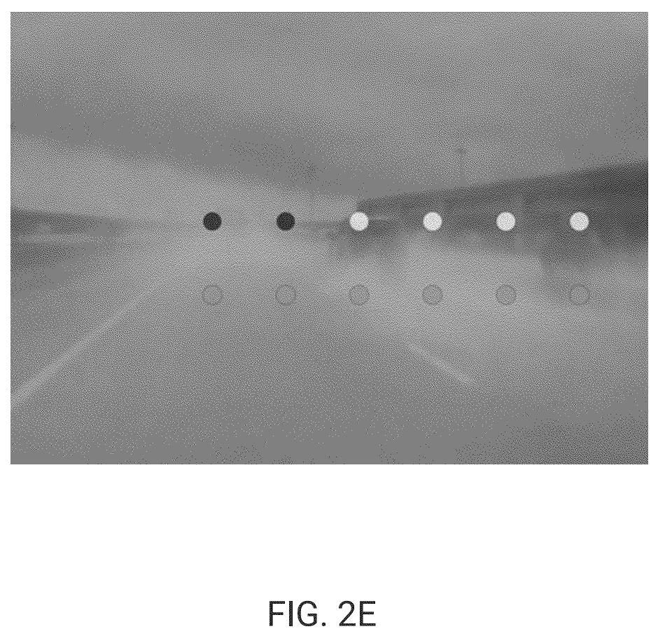

FIG. 2A is a block diagram illustrating a processor system 120 which is included in a vehicle determining visibility information 220 based on received images 200. In the illustrated embodiment, the processor system 120 receives images 200 from a multitude of image sensors (e.g., image sensors 102A-10F). For example, the images 200 may be obtained by the image sensors at a substantially time. As described in FIG. 1, image sensors may be received at a particular frequency such that the processor system 120 generates visibility information 220 at the particular frequency. In some embodiments, the processor system 120 may generate visibility information 220 at a reduced frequency, such as via processing a subset of the received images or combining information from multiple received images.

The processor system 120 may optionally downsample, or otherwise pre-process, the images 200. For example, the images 200 may be received at a first resolution and downsampled to a second resolution (e.g., 320×240, 640×480, 1024×768, and so on). As another example, the images 200 may be cropped, for example to reduce consistent image features which may be included in images (e.g., a portion of a front of the vehicle).

The processor system 120 executes a machine learning model, which in the illustrated example is a convolutional neural network (e.g., the visibility neural network 120). The visibility neural network 120 may be trained using images and label information indicating visibility values for portions of the images. Each visibility value may represent a severity associated with a reduction in visibility for a portion of an image. For example, a visibility value may represent a measure associated with a portion of an image depicting an occlusion or being blurry. As an example, the visibility value may indicate whether the portion cannot be resolved and thus may be masking a real-world object behind it (e.g., fog may be occluding objects behind it).

In some embodiments, visibility values may be assigned based on a grid applied to the images. For example, an image may be divided into a multitude of portions with each portion being assigned a visibility value. In some embodiments, the visibility values may be selected from a range of values (e.g., 0-3, 1-3, 1-8, and so on). As an example, a portion which is severely occluded may receive the highest of the range while a portion which is not occluded may receive the lowest of the range. In some embodiments, only portions of an image which are associated with a reduction in visibility may be assigned visibility values. Thus, remaining portions which are not expected to introduce visibility issues during autonomous operation may not receive assignment of visibility values.

Optionally, a training image may be assigned one or more scene tags indicating reasons for which visibility is reduced. For example, a portion of an image may be assigned a visibility value indicating at least some loss of visibility. In this example, a scene tag may be identified as a label which caused the loss of visibility. Example scene tags may include haze, condensation, ice, water, rain, sun glare, fog, smoke, tire spray, dirty windshield, object in field of view (e.g., roof), hardware fault (e.g., out of focus camera, stuck or dead pixels, and so on).

The visibility neural network 210 may thus be trained using training images which are labeled to indicate visibility values and, in some embodiments, scene tags. The network 210 may include a multitude of convolutional layers followed by one or more fully-connected layers which are trained to output visibility values and, in some embodiments, scene tags.

With respect to training, in some embodiments a multitude of visibility neural networks may be trained and used at inference time by the processor system 120. For example, the left pillar image sensor may have a different visibility neural network than the left repeater. In this example, the visibility neural network for the left pillar may be trained using images obtained from the left pillars of different vehicles which are similar to the vehicle. In contrast, the visibility neural network for the left repeater may be trained using images obtained from the left repeaters of different vehicles.

To ensure that sufficient training data is obtained, the vehicles may optionally execute classifiers which are triggered to obtain images which satisfy certain conditions. For example, vehicles operated by end-users may automatically obtain training images which depict, for example, tire spray, rainy conditions, snow, fog, fire soke, and so on. Further description related to use of classifiers is described in U.S. Patent Pub. No. 2021/0271259 which is hereby incorporated herein by reference in its entirety as if set forth herein.

The processor system 120 may compute respective forward passes through the visibility neural network 210 for the images 200. For example, each image may be considered separately. As described above, each image sensor may be associated with a different neural network. In some embodiments, images from the backup image sensor may not be considered by the processor system 120. While visibility information 220 is illustrated in FIG. 2A, it may be understood that in some embodiments the visibility information 220 is specific to each image sensor. Thus, visibility information 220 may be analyzed by the processor system 120 to determine whether one of the forward image sensors has reduced visibility in contrast to one of the pillar image sensors, and so on.

Example visibility information 220 may include visibility values assigned by the processor system 120 based on the visibility neural network 210. Optionally, visibility information 220 may indicate one or more scene tags as described above.

FIG. 2B is a block diagram illustrating examples of visibility information 232 determined based on a received image 230. The example image 230 may represent an image obtained from a forward image sensor, such as the normal image sensor described above. As illustrated in the image 230, a portion 234 of the image is occluded (e.g., via smoke and/or fog).

The processor system 120 has analyzed the image 230, for example using the machine learning model described above, and has generated visibility information 232 for the image 230. As illustrated, the visibility information 232 indicates that the portion 234 is, at least in part, occluded. For example, the red may indicate a high loss of visibility while the orange may indicate a lesser loss and the white may indicate an event lesser loss. While FIG. 2B illustrates colors, as may be appreciated during operation of the vehicle the processor system 120 may output numerical visibility values for the portion 234.

FIGS. 2C-2E illustrate example images labeled with grids of visibility values. These images may represent training images labeled by persons, such as labeling experts. For example, the persons may use a user interface to assign visibility values to the training images. The images may also represent a graphical representation of output based on the above-described machine learning model.

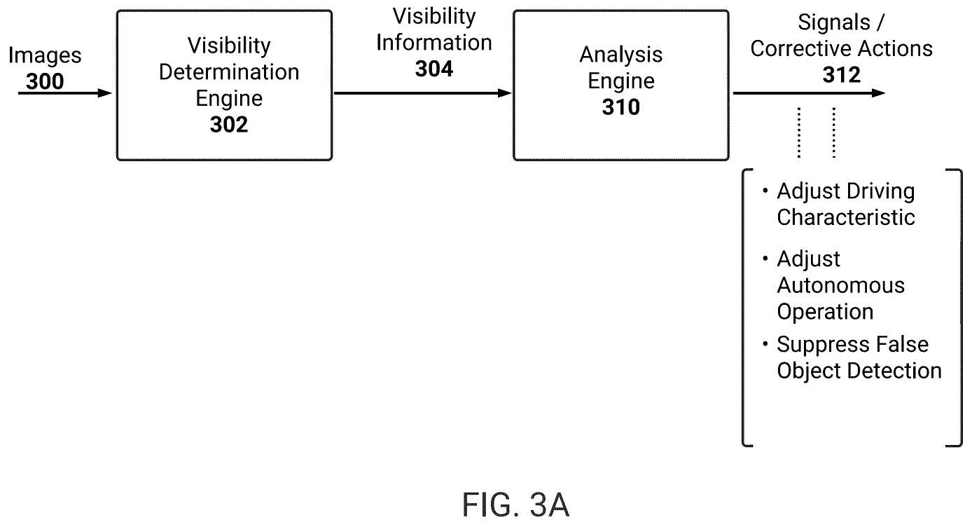

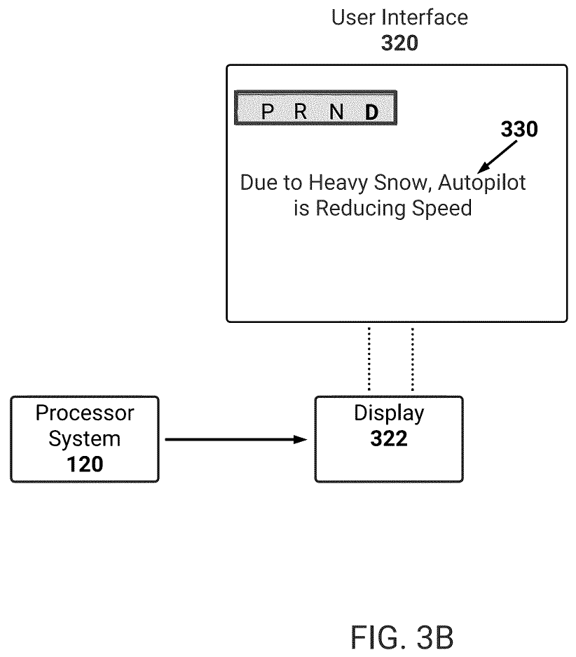

FIG. 3A is a block diagram illustrating example signals/corrective actions 312 to be used by an autonomous vehicle during autonomous operation. As described above, images 300 may be received by the processor system 120 and analyzed to determine visibility information 304. In the illustrated example, the processor system 120 is executing a visibility determination engine 302 to output the visibility information 304. The engine 320 may implement the above-described machine learning model.

FIG. 3A additionally illustrates an analysis engine 310 which outputs signals/corrective actions 312 to be taken based on the visibility information 304. In some embodiments, the analysis engine 310 may represent a vision-based machine learning model which obtains images and determines objects and associated signals based on the images. Thus, the visibility information 304 may represent information provided to as input to a portion of the vision-based machine learning model. The analysis engine 310 may also represent separate logic or a separate model which generates the signals/corrective actions 312.

In some embodiments, and with respect to a range of visibility values between 0-3, if the visibility information 304 includes greater than a threshold number of 3s then the signals/corrective actions 312 may cause the autonomous vehicle to turn off an autonomous mode and have a driver take over. For example, the 3s may be associated with a forward direction (e.g., from forward-facing images) if the autonomous vehicle is moving forward. Similarly, if the autonomous vehicle is going to turn left or right into a different lane the vehicle may have a driver take over if the left and right image sensors have greater than a threshold number of 3s.

With respect to the example visibility values above, the signals/corrective actions 312 may cause the autonomous vehicle to slow down if there are greater than a threshold number of 2s (e.g., associated with images depicting a forward direction). If the visibility values are a mix of 1s and 2s, the autonomous vehicle may reduce a speed temporarily.

In some embodiments, the analysis engine 310 may take greater actions based on images from the forward sensors. For example, if the autonomous vehicle is driving on a highway in a lane going forward, and forward sensors have normal visibility while left and/or right sensors have reduced visibility, then the signals/corrective actions 312 may indicate that the autonomous vehicle can proceed normally. The left and/or right image sensors may be considered, or otherwise weighted more heavily, when an upcoming turn is approaching.

In general, the illustrated signals/corrections actions 312 may include one or more of the following: adjust a driving characteristic, adjust autonomous operation, and suppress false object detection. A driving characteristic may include actions such as slowing down, braking, turning on headlights, turning on hazard lights, turning on wipers (e.g., for a scene tag of rain) and/or windshield heaters, and so on. For example, if the visibility information 304 indicates a scene tag of snow, then the actions 312 may cause the autonomous vehicle to turn on windshield heaters. Adjusting autonomous operation may include changing lanes (e.g., if tire spray is bad in one lane the vehicle may move two lanes over), pulling over, causing a driver to take over, and so on.

Suppressing false object detections may be used by, for example, a vision-based machine learning model to identify times at which an object, such as a vehicle, is not actually positioned proximate to the autonomous vehicle (e.g., a phantom object). For example, due to a visual appearance of certain visibility reducing objects (e.g., smoke, fog), the vision-based machine learning model may inaccurately identify an object as being present proximate to the vehicle. In this example, the object may represent a false positive object which does not exist in the real-world. The vision-based machine learning model may use the visibility information 304 to identify that reduced visibility may be a cause of the phantom object. Thus, certain autonomous operations may be suppressed (e.g., braking for the phantom object).

FIG. 3B is a block diagram illustrating an example user interface 320 identifying an example signal/corrective action. In the illustrated example, a display 322 included in the autonomous vehicle may present a user interface for the benefit of a driver or passenger. As described above, lack of visibility (e.g., in a forward direction, or a direction of travel such as when the autonomous vehicle is turning) may cause autonomous operation to be turned, or otherwise toggled, off. The user interface 320 may therefore present information indicating an adjustment to autonomous operation and a reason 330. In some embodiments, the reason may be determined based on the scene tag (e.g., snow). In some embodiments, the user interface may request a driver or passenger to take an action (e.g., clean an image sensor or housing in which the image sensor is included). In some embodiments, the techniques described herein may determine a hardware fault. For example, over time a portion of an image sensor may experience a fault (e.g., a wire may move, such as to occlude the portion of the image sensor). In this example, the user interface may indicate that the driver or passenger have the image sensor serviced.

### Example Flowchart

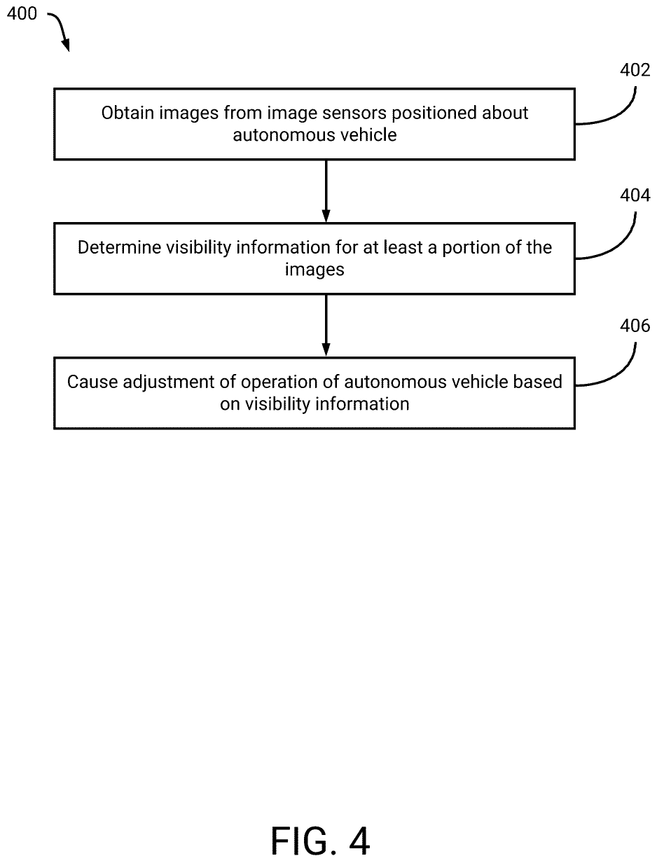

FIG. 4 is a flowchart of an example process 400 for determining visibility information to be used in autonomous driving. For convenience, the process 400 will be described as being performed by a system of one or more processors which is included in a vehicle (e.g., the processor system 120).

At block 402, the system obtains images from image sensors positioned about autonomous vehicle. As illustrated in FIG. 1, the vehicle may include a number of image sensors which provide a substantially 360-degree view about the vehicle.

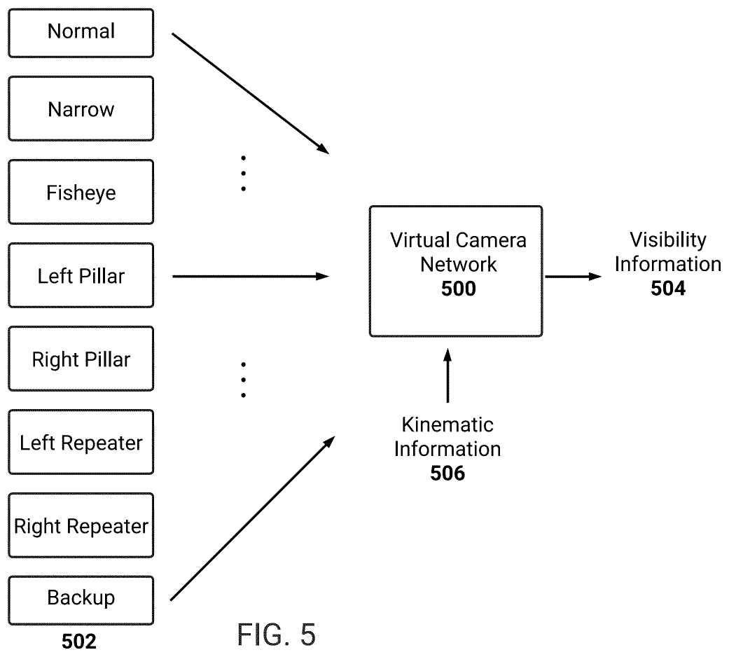

At block 404, the system determines visibility information for at least a portion of the images. As described in FIG. 2A, and as described in FIG. 5 below, the system computes a forward pass through a machine learning model (e.g., a convolutional neural network) to determine visibility information. In some embodiments, each of the image sensors may be associated with a different convolutional neural network. Example visibility information may include visibility values for portions of each image (e.g., according to a grid). Example visibility information may further include one or more scene tags associated with the images.

At block 406, the system causes adjustment of operation of the vehicle based on visibility information. As described in FIG. 3A, and FIG. 5, the system may cause the vehicle to take actions, such as slowing down, braking, changing lanes, turning off autonomous operation, activating windshield heaters, activating defoggers via the air conditioning system, and so on.

### Virtual Camera Network

In some embodiments, a machine learning model (referred to herein as a virtual camera network) may be used to determine information relevant to objects positioned about a vehicle. For example, the objects may be static or dynamic objects. In this example, the virtual camera network may represent a vision-system which detects, and classifies, objects. As an example, and with respect to the above-described visibility information 220, the virtual camera network may segment relevant objects (e.g., rain on image sensors or sensor housing, haze, fog, snow, lens flares or streaks) and determine scene tags (e.g., sun glare, fog).

Example static objects may include objects expected to be substantially fixed or unaltered as an autonomous vehicle navigates. For example, static objects may include lane markings, crosswalks, bike lanes, direction of travel for a road or lane therein, intersections, connectivity between lanes which are separated via an intersection, and so on. Dynamic objects may include objects which are expected to adjust in position, velocity, and so on. Example dynamic objects may include vehicles, pedestrians, bicycles, and so on

As an example of a static object, a lane may be expected to have traffic flow in a same direction as the autonomous vehicle navigates proximate to that lane. In this example, and as may be appreciated, a governmental officer (e.g., a police officer), or sign, may temporarily adjust the direction of traffic. This temporary adjustment may represent a feature or characteristic of the real-world environment and thus may be a static object or information which is detectable via the virtual camera network.

The virtual camera network may associate objects with a vector space according to an orientation or position of a virtual camera. For example, in some embodiments a birds-eye view may be used in which the virtual camera is pointing downwards toward a vehicle. With respect to the above-example static objects, the birds-eye view may allow for a rapid understanding of important elements which are relied upon to effectuate autonomous driving. Indeed, stationary objects may inform the outlines of what is navigable in a real-world environment. For example, lane markings can be included in the birds-eye view as would be seen on a navigation map. In this example, the lane markings may be relied upon to inform future navigation options which are available to an autonomous vehicle. As another example, segmented outlines of puddles, snow, ice, and so on, may inform navigation options available to the vehicle. Additionally, determined scene tags (e.g., and associated confidences) may cause autonomous driving functionality to be altered (e.g., as described above at least in FIGS. 3A-3B.

Another example orientation or position may include the virtual camera being at a distance above the vehicle and pointing forwards (e.g., at a particular angle). Thus, objects which extend further forward may be detected. Additionally, particular objects such as pedestrians may be more reliably detected and associated information (e.g., position, velocity) determined.

The virtual camera network described herein may include disparate elements which, in some embodiments, may be end-to-end trained. Images from image sensors may be provided to respective backbone networks. In some embodiments, these backbone networks may be convolutional neural networks which output feature maps for use later in the network. A transformer network, such as a self-attention network, may receive the feature maps and transform the information into an output vector space. A feature queue may then push the output from the transformer network, optionally along with kinematics of a vehicle (e.g., an autonomous vehicle), into a queue which is optionally spatially indexed. In some embodiments, the feature queue may be spatially indexed such that information is aggregated over a previous threshold distance as the vehicle navigates in a direction. For example, a puddle on the ground may be identified over a distance even as portions of it are occluded in time.

Output from the feature queues may be provided to one or more video modules (e.g., video queues) for processing. In some embodiments, a video module may be a convolutional neural network, a recurrent neural network, or a transformer network. Trunks of the virtual camera network may then obtain output, or a particular portion thereof, from the video module and generate output information using respective heads. The example output may include the above-described information associated with objects, such as visibility information.

FIG. 5 is a block diagram illustrating the processor system determining visibility information 504 using a virtual camera network 500. As illustrated in FIG. 5, backbone networks 502 may receive images from different image sensors as input. Thus, the backbone networks 502 process the raw pixels included in the images. In some embodiments, the backbone networks 502 may be convolutional neural networks. For example, there may be 5, 10, 15, and so on, convolutional layers in each backbone network. In some embodiments, the backbone networks 502 may include residual blocks, recurrent neural network-regulated residual networks, and so on.

The backbone networks 502 may thus output feature maps (e.g., tensors) which are used by virtual camera network 500. In some embodiments, the output from the backbone networks 502 may be combined into a matrix or tensor. In some embodiments, the output may be provided as a multitude of tensors (e.g., 8 tensors in the illustrated example) to the virtual camera network 500.

The output tensors from the backbone networks 502 may be combined (e.g., fused) together into a virtual camera space (e.g., a vector space) via the virtual camera network 500. For example, a transformer network may be trained to perform multi-camera fusion and project information into the vector camera space.

The image sensors positioned about the autonomous vehicle may be at different heights of the vehicle. For example, the left and rear pillar image sensors may be positioned higher than the left and rear front bumper image sensors. Thus, to allow for a consistent view of objects positioned about the vehicle, the virtual camera space may be used. In an example described herein, the virtual camera space is a birds-eye view (e.g., top-down view) of static objects positioned about the autonomous vehicle. In some embodiments, the birds-eye view may extend laterally by about 70 meters, 80 meters, 100 meters, and so on. In some embodiments, the birds-eye view may extend longitudinally by about 80 meters, 100 meters, 120 meters, 150 meters, and so on. For example, the birds-eye view may include static objects which are positioned in a real-world environment in the lateral and/or longitudinal distance.

For certain information determined by the virtual camera network 500, the autonomous vehicle's kinematic information 506 may be used. Example kinematic information 506 may include the autonomous vehicles velocity, acceleration, yaw rate, and so on. In some embodiments, the images may be associated with kinematic information 206 determined for a time, or similar time, at which the images were obtained. For example, the kinematic information 506, such as velocity, yaw rate, acceleration, may be encoded (e.g., embedded into latent space), and associated with the images.

The virtual camera network 500 may include one or more trunks or heads which may be trained to generate specific types of output. In some embodiments, the trunks or heads may relate to edges, lines, dividers, islands, intersections, drivable space, restricted regions, road blockage, traffic flow, crosswalks, visibility, and so on.

The trunks or heads may additionally output the visibility information 504 described herein. For example, the trunks or heads may output certain information which his segmented, such as water droplets on cameras, on roads, haze, camera blockages, lens streaks, and so on as described herein. The trunks or heads may additionally output the scene tags described herein.

As may be appreciated, the virtual camera network 500 may be trained based on ground truth information indicative of different types of visibility information. For example, and with respect to FIG. 2B, an input image 230 may include occluded portions (e.g., due to haze, smoke, and so on). In contrast to the techniques described above with respect to FIGS. 1-4, the virtual camera network 500 may segment the haze. Thus, the network 500 may determine an outline associated with the haze. Similarly, the network 500 may determine a scene tag reflected of the haze or smoke.

The above-described information may be output from the virtual camera 500 and used downstream to, as an example, adjust behavior of autonomous driving. For example, the vehicle may reduce its speed based on reduced visibility caused by the haze or smoke. In this example, the output of the virtual camera network 500 may be used in a seamless manner to indicate segmented objects, and scene tags, which may impact visibility. Thus, the vehicle may intelligently adjust its behavior as described herein, for example in FIGS. 1-4.

In this way, the virtual camera network 500 may reduce an autonomous vehicle's reliance on the numerically labeled training data described herein. For example, and as described above, a user (e.g., a human user or software agent) may assign visibility values to training images. In contrast, the virtual camera network 500 may use ground truth data reflective of segments of objects which cause at least loss of visibility. Similar to a human driver, the network 500 may determine an extent to which heavy rain causes a loss of visibility due to rain covering a windshield, camera, and so on.

### Vehicle Block Diagram

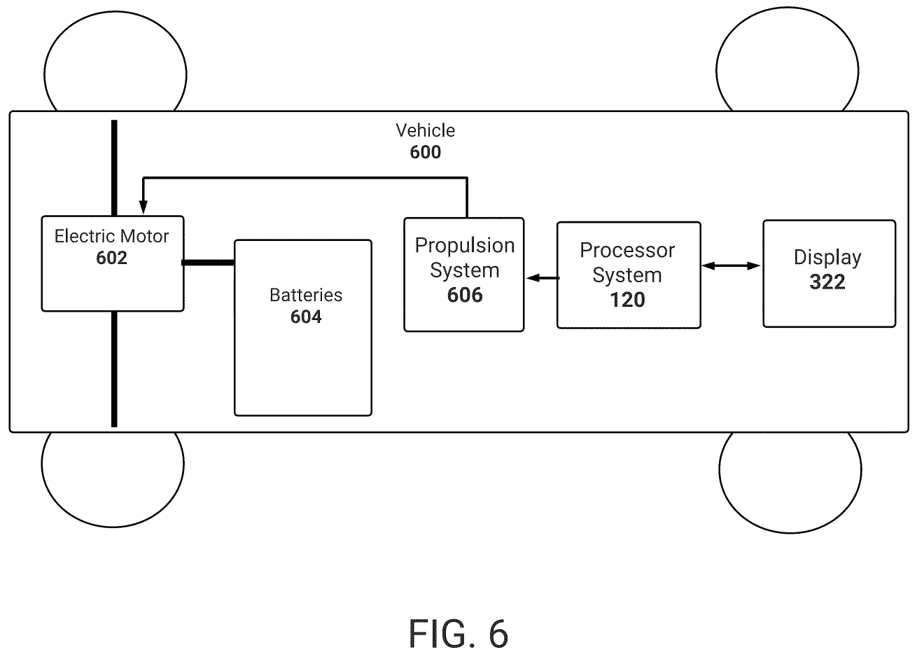

FIG. 6 illustrates a block diagram of a vehicle 600 (e.g., vehicle 100). The vehicle 600 may include one or more electric motors 602 which cause movement of the vehicle 600. The electric motors 602 may include, for example, induction motors, permanent magnet motors, and so on. Batteries 604 (e.g., one or more battery packs each comprising a multitude of batteries) may be used to power the electric motors 602 as is known by those skilled in the art.

The vehicle 600 further includes a propulsion system 606 usable to set a gear (e.g., a propulsion direction) for the vehicle. With respect to an electric vehicle, the propulsion system 606 may adjust operation of the electric motor 602 to change propulsion direction.

Additionally, the vehicle includes the processor system 120 which processes data, such as images received from image sensors 102A-102F positioned about the vehicle 600. The processor system 100 may additionally output information to, and receive information (e.g., user input) from, a display 322 included in the vehicle 600. For example, the display may present graphical depictions of objects positioned about the vehicle 600. As another example, the display may present information associated with determined visibility.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A method comprising:
retrieving, by at least one processor, image data from a sensor of a vehicle;
executing, by the at least one processor, a machine learning model to determine a visibility value for at least a portion of the image data, the visibility value corresponding to a degree of visibility loss associated with at least the portion of the image data; and
providing, by the at least one processor, a control signal to cause an adjustment of operation of the vehicle based on the visibility value.

2. The method of claim 1, wherein providing the control signal to cause the adjustment of operation of the vehicle comprises causing activation of one or more of windshield wipers, a windshield heater, or a defogger.

3. The method of claim 1, wherein causing the adjustment of operation of the vehicle comprises suppressing a false object detection based on the visibility value.

4. The method of claim 1, wherein the machine learning model comprises a convolutional neural network and/or a transformer network.

5. The method of claim 1, wherein the visibility value reflects a scene tag indicative of a label associated with loss of visibility.

6. The method of claim 5, wherein the scene tag comprises haze, rain, smoke, or fog.

7. The method of claim 1, wherein causing the adjustment of operation comprises reducing a speed associated with an autonomous driving mode of the vehicle.

8. The method of claim 1, wherein the visibility value indicates a severity associated with a reduction in visibility for at least the portion of the image data, and wherein the visibility value is selected by the machine learning model from a range of values.

9. A system comprising:
one or more processors and non-transitory computer storage media including instructions that when executed by the one or more processors cause the one or more processors to perform operations, wherein the system is included in a vehicle, and wherein the operations comprise:
retrieving image data from a sensor of a vehicle;
executing a machine learning model to determine a visibility value for at least a portion of the image data, the visibility value corresponding to a degree of visibility loss associated with at least the portion of the image data; and
providing a control signal to cause an adjustment of operation of the vehicle based on the visibility value.

10. The system of claim 9, wherein providing the control signal to cause the adjustment of operation of the vehicle comprises causing activation of one or more of windshield wipers, a windshield heater, or a defogger.

11. The system of claim 9, wherein causing the adjustment of operation of the vehicle comprises suppressing a false object detection based on the visibility value.

12. The system of claim 9, wherein the machine learning model comprises a convolutional neural network and/or a transformer network.

13. The system of claim 9, wherein the visibility value reflects a scene tag indicative of a label associated with loss of visibility.

14. The system of claim 13, wherein the scene tag comprises haze, rain, smoke, or fog.

15. The system of claim 9, wherein causing the adjustment of operation comprises reducing a speed associated with an autonomous driving mode of the vehicle.

16. The system of claim 9, wherein the visibility value indicates a severity associated with a reduction in visibility for at least the portion of the image data, and wherein the visibility value is selected by the machine learning model from a range of values.

17. A system comprising:
a vehicle;
a sensor associated with the vehicle; and
at least one processor in communication with the sensor, the at least one processor configured to:
retrieve image data from the sensor;
execute a machine learning model to determine a visibility value for at least a portion of the image data, the visibility value corresponding to a degree of visibility loss associated with at least the portion of the image data; and
provide a control signal to cause an adjustment of operation of the vehicle based on the visibility value.

18. The system of claim 17, wherein the machine learning model comprises a convolutional neural network and/or a transformer network.

19. The system of claim 17, wherein providing the control signal to cause the adjustment of operation of the vehicle comprises causing activation of one or more of windshield wipers, a windshield heater, or a defogger.

20. The system of claim 17, wherein causing the adjustment of operation of the vehicle comprises suppressing a false object detection based on the visibility value.
